(19) United States
(12) Patent Application Publication
(10) Pub. No.: US 2003/0094722 A1
(43) Pub. Date: May 22, 2003

(54) Producing method of a composite molded article as well as inner mold and metal mold being used for producing cellular molded article in mold pattern having surface skin

(75) Inventors: Kiyoshi Matsuki, Hyogo (JP); Masahiro Chikada, Osaka (JP); Yoriki Kakimoto, Osaka (JP)

Correspondence Address: William R. McClellan, Wolf, Greenfield & Sacks, P.C., 600 Atlantic Avenue, Boston, MA, 02210, US

(73) Assignee: Kaneka Corporation, Osaka-shi (JP)

(21) Appl. No.: 10/329,583

(22) Filed: Dec. 26, 2002

Related U.S. Application Data
(62) Division of application No. 09/736,517, filed on Dec. 13, 2000.

(30) Foreign Application Priority Data
Mar. 29, 2000 (JP) 2000-090279
Mar. 29, 2000 (JP) 2000-090330

(51) Int. Cl. B29C 44/16

(52) U.S. Cl. 264/45.4; 425/4 R

(57) ABSTRACT

A composite molded article of light weight and low cost, and producing method thereof, and also, an inner mold and a metal mold which are used for producing a cellular molded article in mold pattern having surface skin and capable to be preheated even in a condition of opening the metal mold so that the molding cycle can be shortened.

Composite molded article 1 which is composed of cellular molded article 2, surface skin material of thermoplastic resin 3 and at least one kind of surface skin material 4 which is adhered on surface 3a of this surface skin material of thermoplastic resin 3.

### CROSS REFERENCE TO RELATED APPLICATION

This application is a division of U.S. patent application Ser. No. 09/736,517, filed Dec. 13, 2000, entitled COMPOSITE MOLDED ARTICLE AND PRODUCING METHOD THEREOF AS WELL AS INNER MOLD AND METAL MOLD BEING USED FOR PRODUCING CELLULAR MOLDED ARTICLE IN MOLD PATTERN HAVING SURFACE SKIN and now pending.

### TECHNICAL FIELD

This invention relates to a producing method of a composite molded article which is composed of a cellular molded article in mold pattern, a surface skin material of thermoplastic resin, and a surface skin material, and which is used for example as an automobile interior trim material, as well as an inner mold and a metal mold which are used for producing the cellular molded article in mold pattern having surface skin.

### BACKGROUND OF THE INVENTION

(1) As a conventional composite molded article of this kind, for example, an automobile interior trim material can be mentioned. In general, this interior trim material is composed of an interior trim material body, in which a surface skin is adhered on the surface of an injection molded synthetic resin article of panel shape or surface skin shape, or on the surface of a woody substrate, and a design member, in which a fabric surface skin material or the like is adhered on the surface of an injection molded synthetic resin article of panel shape or surface skin shape or on the surface of woody substrate, and the design member is fixed on a prescribed site of the base interior trim material.

(2) And also, it is known as a simultaneous unification molding to one piece, which is, a surface skin material of thermoplastic resin is placed on any one of the two inner molds being fixed on each of two metal mold patterns which compose a total mold pattern, and after the two metal mold patterns are clumped, by means of the expansion molding in this mold pattern, the cellular article to be formed and the surface skin material of thermoplastic resin are melt united to one piece.

In inside of the above mentioned two metal molds, a metal mold chamber having connected with a steam valve or the like is formed up respectively, and at the same time, a metal mold chamber is formed up in each of the inner molds of prescribed shape. A plural number of ventilation holes are formed on the one inner mold on which the surface skin material of thermoplastic resin is placed, and these ventilation holes are connected with a pressure reducing valve by individual pipes respectively for the purpose of such as vacuum forming of the surface skin material of thermoplastic resin. And, on the other inner mold, a plural number of steam holes which connect with a chamber of the metal mold are formed.

At the time of expansion molding, by means of supplying steam into the mold pattern through the steam holes of the other inner mold, the filled expansion beads in this mold pattern are heated and expanded. In this case, in order to carry it out effectively by preheating the surface skin material of thermoplastic resin, before placing this surface skin material of thermoplastic resin, preheating of one of the inner molds in advance is usually performed by supplying steam into the chamber of metal mold.

However, in a interior trim material of the conventional example (1) described above, as an injection molded article of a synthetic resin is employed for the interior trim material body and the design member, it has a problem of heavy weight. And, as the interior trim material body and the design member are produced separately, it needs an additional process of fixing the design member on to the interior trim body, thus it has a problem of high cost.

On the other hand, in the conventional example (2), as the metal mold chamber is pressed by a supplied high pressure steam, preheating of this kind is carried out in a condition of clumping the molds for protection of the metal molds. By this reason, there is a problem of prolonging the molding cycle time of the cellular molded article in mold pattern having surface skin.

This invention has been done for solving the above-mentioned problems, and its first object is to provide a producing method of a composite molded article of light weight as well as low production cost.

And its second object is to provide an inner mold and a metal mold which are used for producing an cellular molded article in mold pattern having surface skin, in which the preheating of mold patterns can be made in open position of them and thus the molding cycle time can be shortened.

### DISCLOSURE OF THE INVENTION

To achieve the above objects, an essential feature residing in a producing method of composite molded article is that, a producing method of a composite molded article by a process of that, a surface skin material of thermoplastic resin is placed on either one of two metal mold patterns which compose a mold pattern, and after clumping the mold, by means of expansion molding in this mold pattern, a cellular molded article in mold pattern to be formed and the above mentioned surface skin material of thermoplastic resin are melt united to one piece, wherein before placing the above mentioned surface skin material of thermoplastic resin, at least one kind of surface skin material is placed on either one of the above mentioned metal molds, and at the same time or before then, the surface skin material of thermoplastic resin and the surface skin material are melt united together to one piece.

An essential feature residing in a producing method of a composite molded article which is claimed in claim 1 is that, one or more kinds of surface skin material having the different properties and outward appearance of the surface skin material of thermoplastic resin are melt united to one piece on a portion of the surface of the surface skin material of thermoplastic resin.

An essential feature residing in a producing method of a composite molded article which is claimed in claim 1 is that, the quality of above mentioned surface skin material is different from the quality of above mentioned surface skin material of thermoplastic resin.

An essential feature residing in a producing method of a composite molded article which is claimed in claim 1 is that, the above mentioned surface skin material is made of cloth, knitting or non-woven fabric.

An essential feature residing in a producing method of a composite molded article which is claimed in claim 1 is that, the above mentioned surface skin material is composed of a thermoplastic resin.

An essential feature residing in a producing method of a composite molded article which is claimed in claim 5 is that, the above mentioned cellular molded article in mold pattern, the above mentioned surface skin material of thermoplastic resin and the above mentioned surface skin material are composed of an olefin resin.

An essential feature residing in a producing method of a composite molded article which is claimed in claim 6 is that, the above mentioned olefin resin is a polypropylene resin.

An essential feature residing in a producing method of a composite molded article which is claimed in claim 1 is that, a surface treatment is performed on at least either the above mentioned surface skin material of thermoplastic resin or the above mentioned surface skin material.

An essential feature residing in a producing method of a composite molded article which is claimed in claim 1 is that, at least a portion of the edge part of above mentioned surface skin material is inserted in a groove part which is formed on the surface of above mentioned surface skin material of thermoplastic resin.

An essential feature residing in a producing method of a composite molded article which is claimed in claim 1 is that, the above mentioned surface skin material is laminated with a lining material on its back face.

An essential feature residing in a producing method of a composite molded article which is claimed in claim 10 is that, the above mentioned lining material is a cross-linked cellular article.

An essential feature residing in a producing method of a composite molded article which is claimed in claim 10 is that, the above mentioned lining material is composed of a thermoplastic resin.

An essential feature residing in a producing method of a composite molded article which is claimed in claim 12 is that, the above mentioned lining material is composed of an olefin resin.

An essential feature residing in a producing method of a composite molded article which is claimed in claim 13 is that, the above mentioned olefin resin is a polypropylene resin.

An essential feature residing in a producing method of a composite molded article which is claimed in claim 1 is that, it is an interior trim material for automobile, ship, train or aircraft.

An essential feature residing in an inner mold is that, an inner mold which is used for producing a cellular molded article in mold pattern by employing a step that, on either one of the two inner molds being fixed on each of two metal mold patterns which compose a mold pattern, a surface skin material of thermoplastic resin is placed, then clumping the mold, and thereafter, by an expansion molding of it in this mold pattern, a cellular molded article in mold pattern to be formed and the above mentioned surface skin material of thermoplastic resin are melt united together to one piece, wherein, at least one chamber is mounted in the above mentioned one of inner molds.

An essential feature residing in an inner mold which is claimed in claim 16 is that, at least one chamber for heating and one chamber for cooling are mounted in the above mentioned one of inner molds.

An essential feature residing in an inner mold which is claimed in claim 16 is that, a plural number of ventilation holes are formed on the above mentioned one of inner molds.

An essential feature residing in an inner mold which is claimed in claim 18 is that, the above mentioned ventilation holes are disconnected with the above mentioned chamber, and these holes are connected with a metal mold chamber which is mounted in the metal mold with which the above mentioned one of inner molds is fixed.

An essential feature residing in an inner mold which is claimed in claim 16 is composed of a surface mold consisting a design face of the above mentioned one of inner molds and at least one back plate which is fixed so as to form the above mentioned chamber on back face of this surface mold.

An essential feature residing in an inner mold which is claimed in claim 20 is that, ventilation holes being formed on the above mentioned surface mold and chamber holes being formed on the above mentioned back plate are melt united to one piece through at least one hollow joint pillar which is connecting with both of them.

An essential feature residing in a metal mold is that, a metal mold is equipped with the inner mold which is claimed in claim 16.

### BRIEF DESCRIPTION OF THE DRAWINGS

For the better understanding of the invention as well as other objects and features thereof, reference is made to the following detailed description to be read in conjunction with the accompanying drawings, wherein:

FIG. 1 is a schematic sectional view of a composite molded article which is relating to embodiment 1.

FIG. 2 is a schematic sectional view illustrating a condition of placing the surface skin material on one of the inner molds.

FIG. 3 is a schematic sectional view illustrating a condition of placing the surface skin material of thermoplastic resin after the surface skin material is placed on.

FIG. 4 is a schematic sectional view of illustrating a condition of filling the expanded beads into the mold pattern.

FIG. 5 is a schematic sectional view of illustrating a condition of the expansion molding.

FIG. 6 is a schematic sectional view of the composite molded article which is relating to embodiment 2.

FIG. 7 is a schematic sectional view of illustrating a condition of placing the surface skin material of thermoplastic resin on after the surface skin material is placed on.

FIG. 8 is a schematic sectional view of the composite molded article which is relating to embodiment 3.

FIG. 9 is a schematic sectional view of illustrating a condition of placing the surface skin material of thermoplastic resin on after the surface skin material with a lining material on its back face is placed on.

FIG. 10 is a schematic sectional view of illustrating that the inner mold which is relating to embodiment 4 is fixed in the female mold.

FIG. 11 is an enlarged sectional view of essential portion of the hollow joint pillar part in the inner mold of FIG. 10.

FIG. 12 is a schematic sectional view which illustrates a condition of filling the expanded beads into the mold pattern.

FIG. 13 is a sectional view of illustrating a condition of the expansion molding.

FIG. 14 is a sectional view of the cellular molded article in mold pattern having surface skin.

In the above mentioned drawings, marks represent as follows;

1, 21, 31: composite molded article

2: cellular molded article in mold pattern

2a: surface

3: surface skin material of thermoplastic resin

3a: surface

4: surface skin material

4b: back face

4c: edge part

5: groove part

C: female mold (metal mold)

B: male mold (metal mold)

7: inside of mold pattern

11: expanded beads

32: lining material

32c: edge part

41: one of inner molds

42: cellular molded article in mold pattern having surface skin

43: chamber

44: surface mold

44a: design face

44b: back face

45: back plate

46: ventilation holes

47: chamber holes

48: hollow joint pillar

A1: metal mold chamber

B1: metal mold chamber

61: the other inner mold

### BEST MODE FOR PRACTICING THE INVENTION

Embodiments of this invention are described below.

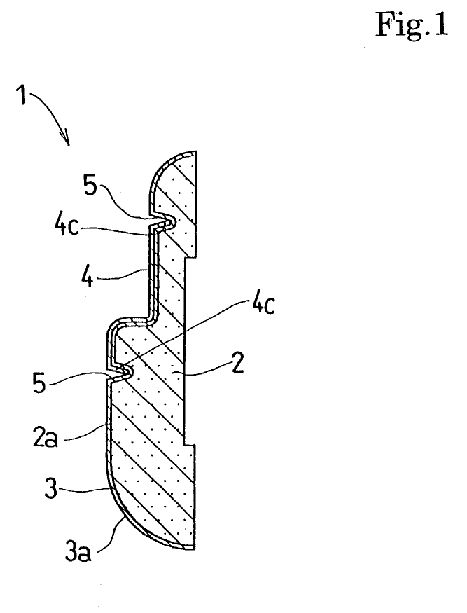

As is illustrated in FIG. 1, composite molded article 1 which is related to embodiment 1 is composed of cellular molded article in mold pattern 2, surface skin material of thermoplastic resin 3 which is adhered on surface 2a of this cellular molded article 2, and surface skin material 4 which is adhered on surface 3a of this surface skin material of thermoplastic resin 3.

Cellular molded article in mold pattern 2 is formed by that expanded beads being composed of a thermoplastic resin are expansion-molded (expansion in mold) in a molding pattern of prescribed shape. As the expanded beads, each kind of known material such as olefin resin or styrene resin can be employed. As an expansion magnification of these expanded beads which are employed in this expansion molding in mold pattern, in a case of less than three times, cushioning or such other property of cellular molded article in mold pattern 2 to be molded by this process will be decreased, and, in a case of more than sixty times, cellular molded article in mold 2 will be too softened and accordingly the strength or the like will be decreased. Therefore three to sixty times magnification of the expanded beads, preferably five to fifty times, more preferably eight to forty five times, most preferably ten to thirty five times, is desirable. And as such beads, for example, Eperan PP (trade name, made by Kanegafuchi Chemical Industry Co.) can be effectively employed.

Surface skin material of thermoplastic resin 3 which has been formed in a sheet shape of prescribed thickness made from, for example, polyvinyl chloride resin, olefin resin such as polyethylene or polypropylene, is adhered on surface 2a of cellular molded article in mold pattern 2. This surface skin material of thermoplastic resin 3 may be adhered on cellular molded article in mold pattern 2 by an adhesive or the like, however, in a case of melt uniting to one piece, as it can be easily produced by a simultaneous melt unification molding to one piece, there is a merit in cost saving. In order to make a melt unification molding, both of cellular molded article in mold pattern 2 and surface skin material of thermoplastic resin 3 are made to have heat adhesion property by employing a hot-melt adhesive, a thermoplastic resin sheet, a cellular sheet of cross-linked or non-cross-linked thermoplastic resin which is coated or laminated on in advance, or by making cellular molded article in mold pattern 2 and surface skin material of thermoplastic resin 3 to be the same thermoplastic resin composition or similar thermoplastic resin composition, and then, these can be adhered each other directly or melt united by heat.

Surface skin material 4 is consisted of an appropriate sheet material of prescribed thickness, and is adhered on surface 3a of surface skin material of thermoplastic resin 3. Also this surface skin material 4 can be easily produced by a simultaneous melt unification molding to one piece, as same as in the above, in a case of making melt uniting to one piece with surface skin material of thermoplastic resin 3, accordingly there is a merit of making cost down. And in a case that the surface condition of surface skin material 4 is different from the surface condition of surface skin material of thermoplastic resin 3, as the portion of surface skin material 4 can be distinguished by eye from the portion of surface skin material of thermoplastic resin 3, there is a merit of easy obtaining of a decorative effect. In the above description, “the surface condition is different” means that at least anyone of appearance, touch, tone, etc. of the color, design, embossing design, weaving style, knitting style or the like is different.

In a case of the quality of surface skin material 4 being different from the quality of surface skin material of thermoplastic resin 3, there is a merit that these surface conditions can be easily made to be different each other. And in a case that surface skin material 4 is made of cloth, knitting or non-woven fabric, there is a merit that a decoration property can be given more effectively. In further, in a case that surface skin material 4 is made from a thermoplastic resin, there is a merit that direct melt uniting by heat on surface skin material of thermoplastic resin 3 can be made. The kind of surface skin material 4 is not limited to one kind as in this embodiment but 2 or more kinds of different surface condition or the like can be adhered on a prescribed site with a prescribed size. And, the number in the same kind of surface skin material 4 is also not particularly limited but a prescribed plural number of it can be adhered on if necessary.

In this stage, in a case that cellular molded article in mold pattern 2, surface skin material of thermoplastic resin 3 and surface skin material 4 are made from olefin resin, as it is so called an all olefin, there is a merit of making easy recycling. In a case that the olefin resin is polypropylene resin, there is a merit that a high durability can be given. As this polypropylene resin, for example, propylene homopolymer, ethylene-propylene random copolymer, ethylene-propylene block copolymer, ethylene-propylene-butene terpolymer, propylene-vinyl chloride copolymer, propylene-butene copolymer and propylene-maleic acid anhydride copolymer can be mentioned among others, and these can be used alone or as a mixture of not less than two of them. The polypropylene resin is preferably not cross-linked however, it may also be cross-linked by using a peroxide, radiation or the like. Further more, a mixture of the polypropylene resin and other thermoplastic resin can also be used. As this kind of thermoplastic resin, for example, low density polyethylene, linear low density polyethylene, aromatic vinyl polymer, polybutene and ionomer can be mentioned among others. And as an amount of the thermoplastic resin to be mixed with, not more than 20 parts by weight of it against 100 parts by weight of the polypropylene resin, preferably 5 to 10 parts by weight, is desirable.

In a case of surface treatment being made on either one of surface skin material of thermoplastic resin 3 and surface skin material 4, there is a merit that its weatherability, durability against scratching and such other properties can be improved. As such surface treatment, for example, chemical reaction on the surface by a chemical substance, graft-polymerization of a monomer or polymer on this surface, chemical treatment of the surface by coating a thin membrane, roughing the surface by a mechanical method, plasma treatment, irradiation of ultra-violet light and flame treatment, irradiation of ion beam can be mentioned among others.

In a case that at least a portion of edge part 4c of surface skin material 4 is inserted in groove part 5 which is formed on surface 3a of surface skin material of thermoplastic resin 3, as edge part 4c which is inserted in groove part 5 is hidden and thus it is hardly seen, there is a merit of that it looks well, and at the same time, it can be prevented from peeling off from edge part 4c. Groove part 5 can be formed by that surface skin material of thermoplastic resin 3 is adhered along the groove of same shape which is mounted on surface 2a of cellular molded article in mold pattern 2.

As is mentioned above, composite molded article 1 is composed of cellular molded article 2, surface skin material of thermoplastic resin 3 and at least one kind of surface skin material 4, and therefore there is a merit that it is light weight, at the same time, the producing method of it is simple so that the production cost can be cut down.

Next, a producing method of composite molded article 1 which is constituted as in the above will be explained.

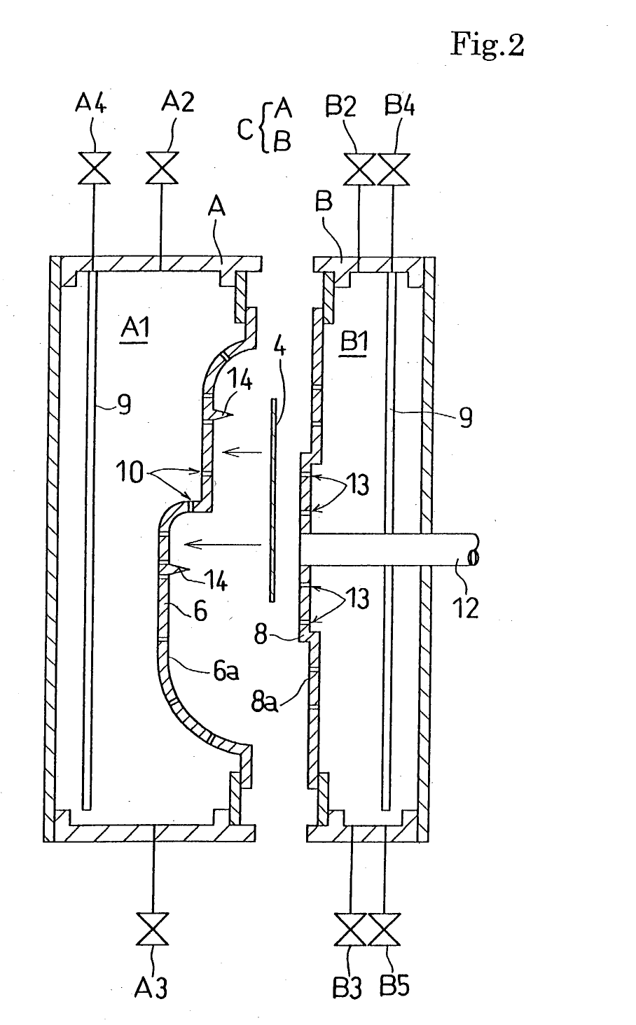

As illustrated in FIG. 2 to FIG. 5, the producing method relating to this embodiment is that in female mold (metal mold) A and male mold (metal mold) B which are constituting mold pattern C, for example, surface skin material of thermoplastic resin 3 is placed on inner mold 6 of female mold A, and then after clumping, by means of expansion molding in this mold pattern 7, cellular molded article in mold pattern 2 and surface skin material of thermoplastic resin 3 are melt united together to one piece, wherein before placing surface skin material of thermoplastic resin 3 on, surface skin material 4 is placed on inner mold 6 in advance, and at the same time or before then, these surface skin material of thermoplastic resin 3 and surface skin material 4 are melt united together to one piece.

Mold pattern C is constituted for example of female mold (metal mold) A, which is capable to clump and open in horizontal direction, and male mold (metal mold) B. Inner mold 6 of concave shape in horizontal sectional view for example is fixed in female mold A, and inner mold 8 of convex shape in horizontal view for example is fixed in male mold B. And, inner mold 6 and 8 are not particularly limited to these horizontal sectional shapes, they can be changeable according to the shape of composite molded article 1 or the like to be produced. On the other hand, on designed face 6a and 8a of inner mold 6 and 8 respectively, an unevenness for design pattern such as embossing a leather pattern can be formed if necessary. And also, mold pattern C can be made to clump and open in vertical direction or the like other than in horizontal direction.

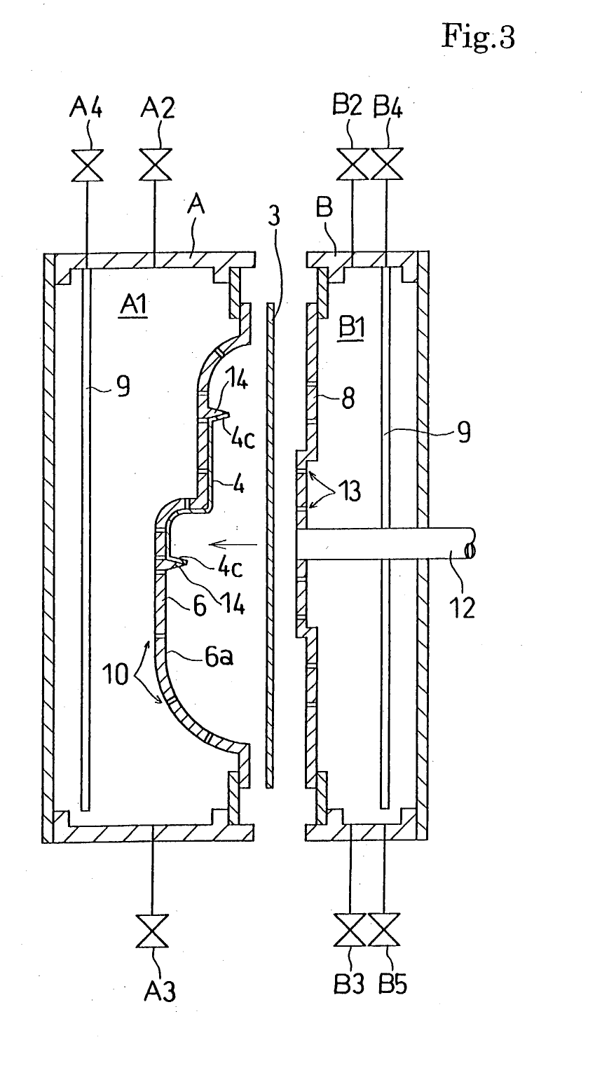

In order to produce composite molded article 1, as is illustrated in FIG. 2 and FIG. 3, at first, surface skin material 4 is placed on one of inner mold 6 which is fixed in female mold A.

In this stage, metal mold chamber A1 is mounted in female mold A, and steam valve A2 and drain valve A3 are connected with this metal mold chamber A1. Cooling water valve A4 is connected with pipe for cooling 9 which is mounted in metal chamber A1, and from the nozzles formed at prescribed positions of pipe for cooling 9 (not shown), cooling water can be sprayed. And a plural number of ventilation holes 10 are formed on one of inner molds 6, and these ventilation holes 10 are connected with a pressure reducing valve (not shown) through separate pipes respectively.

Also, metal mold chamber B1 is mounted in male mold B, and, steam valve B2, drain valve B3 and pressure reducing valve B5 are connected with it. Pipe for cooling 9 which is mounted in metal mold chamber B1 is connected with cooling water valve B4, and cooling water can be sprayed from the nozzles (not shown) mounted at prescribed positions of pipe for cooling 9. On male mold B, feeder 12 for filling expanded beads 11 into mold pattern 7 is mounted. On the other inner mold 8 which is fixed in this male mold B, a plural number of steam holes, which are connected with metal mold chamber B1, are formed.

To place surface skin material 4 on one of inner molds 6, by means of suctioning the air from ventilation holes 10 by opening the pressure reducing valve, surface skin material 4 is made to tight contact with design face 6a. In this step, in order to insert edge part 4c of surface skin material 4 into the above mentioned groove part 5, projection part 14 is mounted on design face 6a of one of inner molds 6 so as to surround a prescribed range, and edge part 4c of surface skin material 4 is placed on at about the tip position of projection part 14. And, projection part 14 can be mounted by bending, casting or by such others of inner mold 6 itself into inverted V letter shape or inverted U letter shape. While, in a case that only a portion of edge part 4c of surface skin material 4 is inserted into groove part 5, projection part 14 is mounted on only corresponding position to it

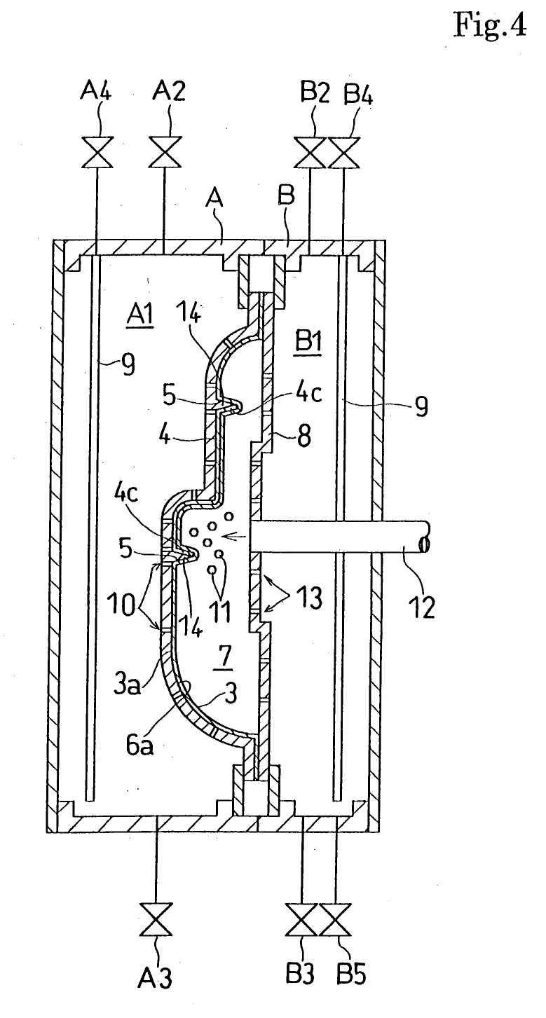

Next, as is illustrated in FIG. 3 and FIG. 4, surface skin material of thermoplastic resin 3 is placed on one of inner molds 6. At this step, in projection part 14, groove part 5 is formed on surface 3a of surface skin material of thermoplastic resin 3, and edge part 4c of surface skin material 4 becomes to be in a position of inserted into this groove part 5.

In this case, formed surface skin material of thermoplastic resin 3, which is conformed to the shape of design face 6a of inner mold 6 by vacuum forming or the like with using other metal mold or the like in advance, may be employed, however, to omit this work, it is preferable that the thermoforming by such as vacuum forming is carried out in inner mold 6. As the thermo-forming, for example, compression molding, vacuum-compression forming or such others can be applied other than vacuum forming.

To carry out the thermo-forming in inner mold 6, surface skin material of thermoplastic resin 3 is contacted to inner mold 6 in a condition of softened by heat in advance, and then, surface skin material of thermoplastic resin 3 is tightly contacted with design face 6a of inner mold 6 by suctioning air through ventilation holes 10 by opening the pressure reducing valve. In this case, in order to carry it out effectively by minimizing the temperature drop of softened surface skin material of thermoplastic resin 3, it is desirable to pre-heat design face 6a at a prescribed temperature, and this pre-heating can be made by supplying steam into metal mold chamber A1 by opening steam valve A2.

While, in a case that surface skin material 4 is composed of a thermoplastic resin, as same as in the above mentioned, this surface skin material 4 may also be placed by thermo-forming. Or, surface skin material 4 is composed of a thermoplastic resin which is the same or similar composition of surface skin material of thermoplastic resin 3, or in further, a hot melt adhesive, a thermoplastic resin sheet or the like which has heat melt adhesion property with both of surface skin material 4 and surface skin material of thermoplastic resin 3 is coated or laminated on anyone of them in advance, so that the heat melt adhesion of surface skin material 4 with surface skin material of thermoplastic resin 3 can be started from the beginning of placement of them.

After surface skin material of thermoplastic resin 3 being placed on, as illustrated in FIG. 4, the molds are clumped and expanded beads 11 are filled into mold pattern 7. At this step, to make easy evacuation of air in mold pattern 7, the clumping of mold patterns may be carried out in a condition of having small opening between the mold patterns (cracking condition).

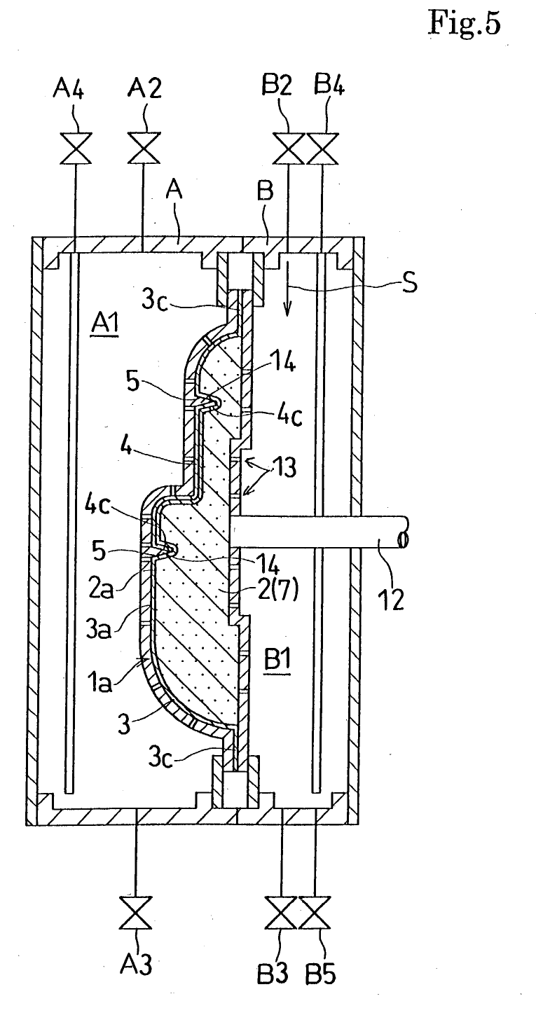

Next, as illustrated in FIG. 5, by opening steam valve B which is connected with metal mold chamber B1 of male mold B, steam S is supplied into mold pattern 7 through steam holes 13 of the other inner mold 8 and thus expanded beads 11 are heat-expanded. At this heat expansion, to avoid causing an insufficient melt adhesion, according to its necessity, preheating by steam S at a lower temperature than the melt uniting temperature of each of them, or steaming for a prescribed time at this condition, or in further, after this steaming, evacuation of drain in mold pattern 7 in advance by vacuum suction through steam holes 13 by opening pressure reducing valve B5, may be carried out.

After then, by steps of cooling down according to its necessity, opening the mold pattern and taking out from the mold, composite molded article 1a having edge part 3c, which is composed of cellular molded article in mold pattern 2 which is formed by the expansion of expanded beads 11 in mold, surface skin material of thermoplastic resin 3 which is melt united to one piece with surface 2a of this cellular molded article 2, and surface skin material 4 which is melt united to one piece with surface 3a of this surface skin material of thermoplastic resin 3, can be obtained. Continuously, by cutting off edge part 3c, composite molded article 1 as illustrated in FIG. 1 can be obtained. By such producing method, composite molded article 1 can easily be produced by a simultaneous molding to one piece, thus there is a merit of cutting down its production cost.

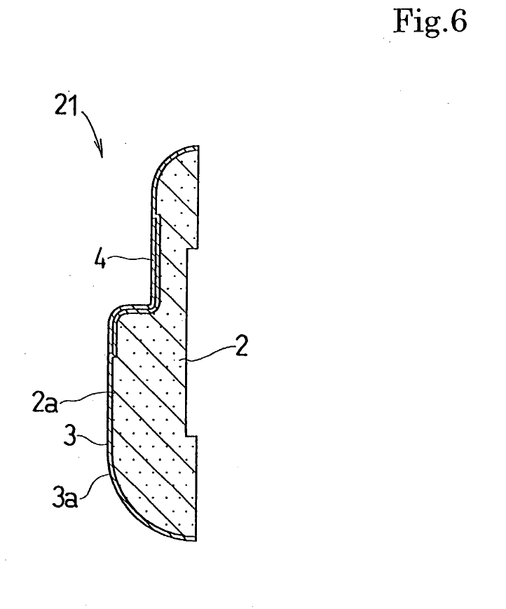

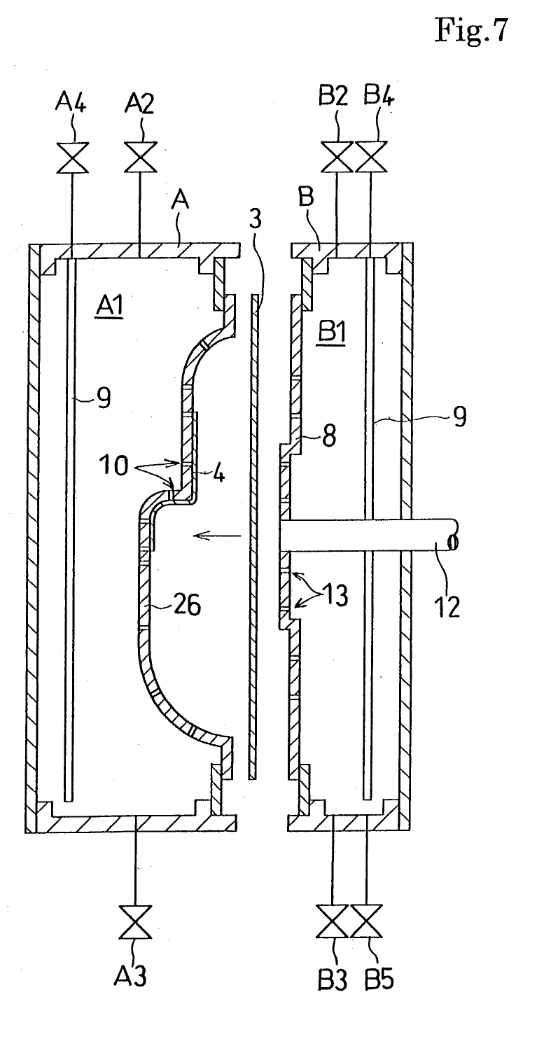

As illustrated in FIG. 6, composite molded article 21, which is relating to embodiment 2, is that, in embodiment 1, surface skin material 4 is adhered on surface 3a of surface skin material of thermoplastic resin 3 in which groove part 5 is not formed. In order to produce composite molded article 21 or such kind, as is illustrated in FIG. 7, inner mold 26 or the like, in which above mentioned projection part 14 is not mounted, may be employed.

In this process, surface skin material 4 can simply be adhered, and in this case, its surface is floating up by its thickness from surface 3a of surface skin material of thermoplastic resin 3, however, it is desirable to produce it as same as in embodiment 1 by employing inner mold 26 which is illustrated in FIG. 7 or the like. In this case, as is illustrated in FIG. 6, surface skin material 4 becomes to a condition of being buried in surface 3a of surface skin material of thermoplastic resin 3, and thus, as surface skin material 4 becomes to be the same surface level as surface 3a of surface skin material of thermoplastic resin 3, there is a merit of good appearance.

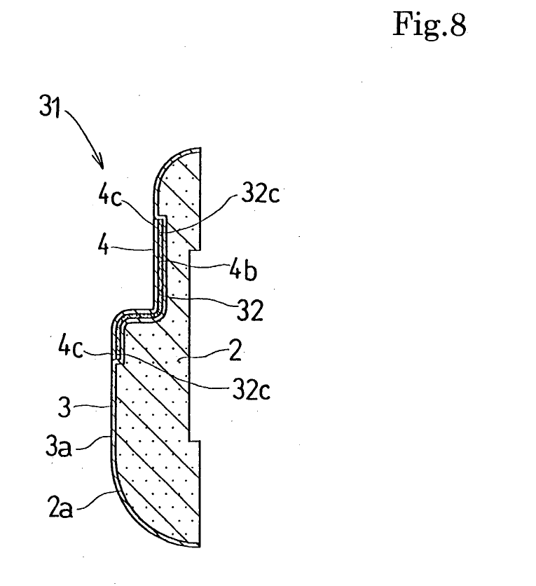

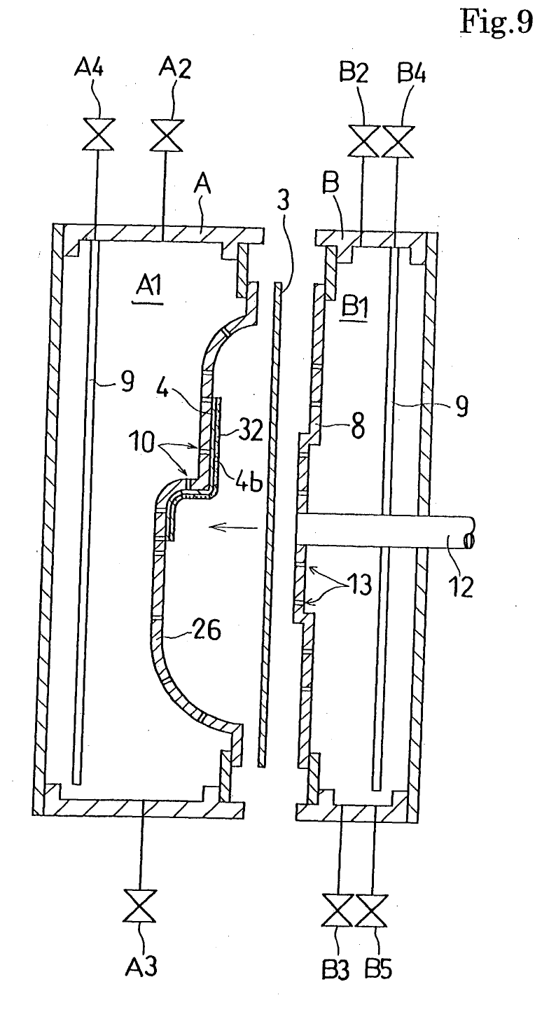

As illustrated in FIG. 8, composite molded article 31 which is relating to embodiment 3, is that, in embodiment 2, lining material 32 is laminated on back face 4b of surface skin material 4. In order to produce such composite molded article 31, as illustrated in FIG. 9, as same as in embodiment 2, together with employing inner mold 26 or the like in which projection part 14 is not mounted, and surface skin material 4, in which lining material 32 is laminated on its back face 4b, is placed on so as to make tight contact with inner mold 26 or the like, however, as same as in embodiment 1, by employing inner mold 6 or the like to which projection part 14 is mounted, edge part 4c of surface skin material 4 and edge part 32c of lining material 32 may also be inserted into the above mentioned groove part 5.

As is seen in the above, by laminating lining material 32 on back face 4b of surface skin material 4, there is a merit of making a different touch or the like on surface material 4. In a case that this lining material 32 is a cross-linked cellular molded article, there is a merit of good touch and high durability. In a case that lining material 32 is composed of a thermoplastic resin, there is a merit that it can be made a heat melt adhesion directly on surface skin material of thermoplastic resin 3. And also in this case, as illustrated in FIG. 8, surface skin material 4 and lining material 32 become to be buried in surface 3a of surface skin material of thermoplastic resin 3, therefore surface skin material 4 is preferably made to be a same surface level as surface 3a of surface skin material of thermoplastic resin 3.

While, in a case that lining material 32 is composed of an olefin resin, this lining material 32 is easily recycled, however, in this case, by means that all of cellular molded article in mold pattern 2, surface skin material of thermoplastic resin 3 and surface skin material 4 are composed of an olefin resin, so called all olefin is desirable.

In addition, the usage of composite molded article 1, 21 or 31 described in embodiment 1 to 3 is not particularly limited but it can be applied for various kinds of member material. In particular, in case that it is employed as an interior trim material for automobile, ship, train or aircraft, there is a merit of providing an automobile or such others of light weight as well as low cost.

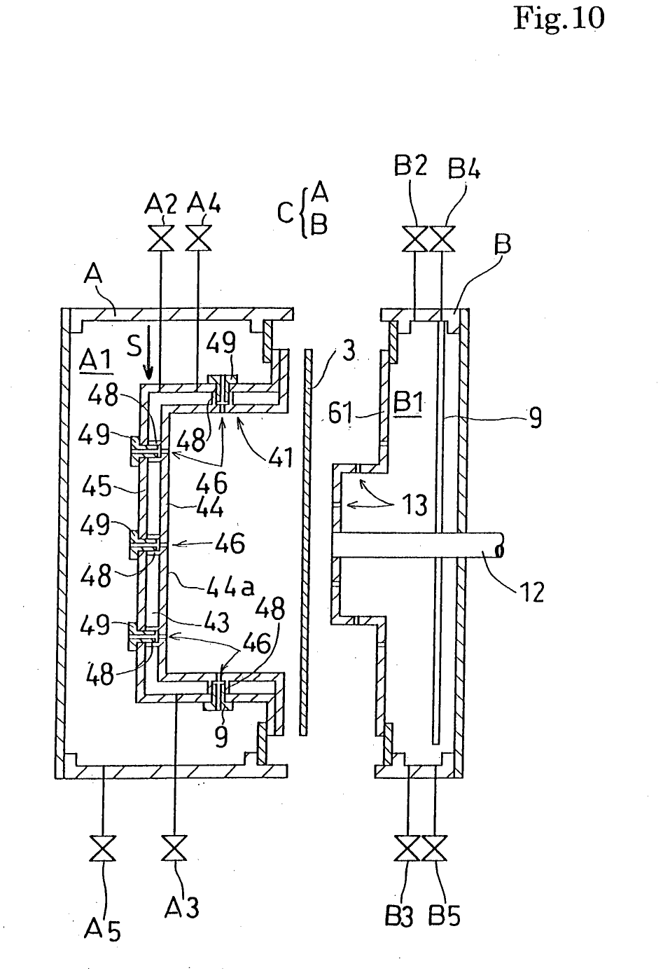

As illustrated in FIG. 10 to FIG. 14, inner mold 41, which is relating to embodiment 4, is employed for producing cellular molded article in mold pattern having surface skin 42, and it is equipped with chamber 43 in its inner portion.

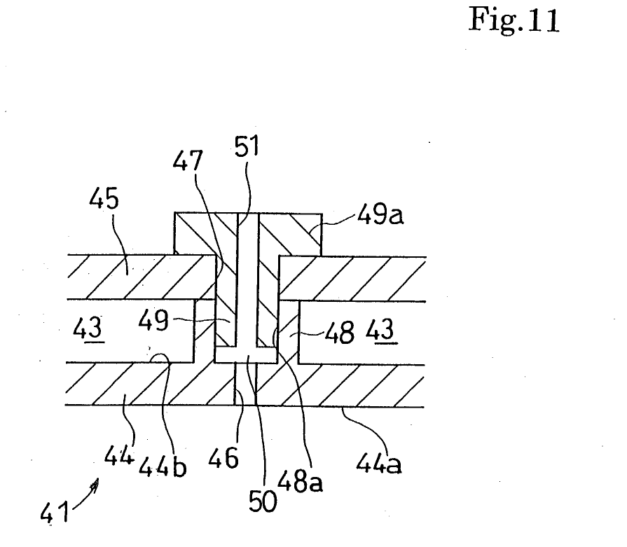

This inner mold 41 is, for example as illustrated in FIG. 10 and FIG. 11, composed by surface mold 44 which consists of design face 44a and back plate 45 which is fixed so as to form chamber 43 on back face 44b of this surface mold 44, at the same time, it is connected in one piece shape with ventilation holes 46 which are mounted on surface mold 44 and chamber holes 47 which are mounted on back plate 45 through a plural number of hollow joint pillars 48.

And, the horizontal sectional views of surface mold 44 and back plate 45 are depicted in concave shape in this embodiment, however, they are not limited to this but they can be changeable according to the shape or the like of cellular molded article in mold pattern having surface skin 42 to be produced. While, on design face 44a, an unevenness for design pattern such as leather shape embossing or the like can also be formed if necessary.

Hollow joint pillar 48 is formed for example to a cylindrical shape, and it is projected on back face 44b of surface mold 44 at the site where corresponds to the site of ventilation hole 46. Chamber hole 47 of back plate 45 is formed at the site where corresponds to the site of these ventilation hole 46 and hollow joint pillar 48. And, on inner face 48a of hollow joint pillar 48, a female screw is formed, and thus, in between the edge part of this hollow joint pillar 48 and head part 49a of bolt 49 which is inserted through chamber hole 47 and will be screwed up with the above mentioned female screw, back plate 45 will be fixed on by screwing.

And, on design face 44a, surface skin material of thermoplastic resin 3 which will become the surface skin of cellular molded article in mold pattern having surface skin 42 is placed, therefore, it is desirable to make screwing of bolt 49 at back plate 45 side as in this embodiment. In this case, hollow joint pillar 48 may be fixed by welding or adhesion of a separately composed one on other body, or may be projected on back face 44b of surface mold 44 by an unification molding to one piece with employing a casting or the like, however, in a case that bolt 49 is possible to make direct screwing to surface mold 44, it is also possible to make projection on back plate 45 by the same manner. In bolt 49, inside cavity 50, ventilation hole 46 of surface mold 44 and connecting hole 51 may be formed. While, back plate 45 is not limited to be formed into one piece but it may also be possible to be divided into a plural number of pieces at a prescribed site.

Inner mold 41, which is constituted as described in the above, is fixed on female mold A of mold pattern C as is illustrated in FIG. 10 for example, and also, inner mold 61, for example, of convex shape in horizontal sectional view is fixed on male mold B.

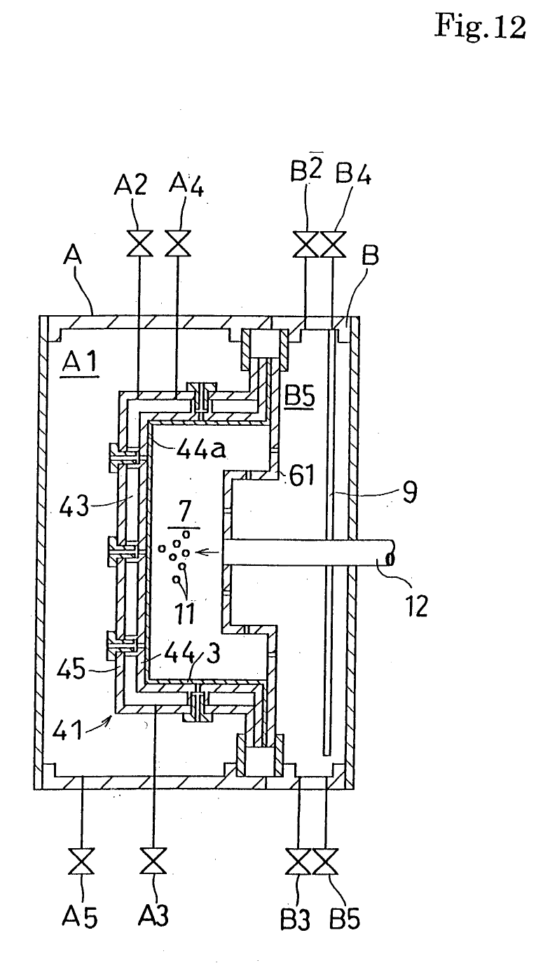

In order to produce cellular molded article in mold pattern having surface skin 42, as illustrated in FIG. 10 and FIG. 12, at first, surface skin material of thermoplastic resin 3 is placed on one of inner molds 41 which is fixed on female mold A.

Here, steam valve A2, drain valve A3 and cooling water valve A4 are connected with chamber 43 of one of inner molds 41. Metal mold chamber A1 is mounted in female mold A, and pressure reducing valve A5 is connected with this metal mold chamber A1. And, a plural number of ventilation holes 46 which are formed on surface mold 44 are connected with metal mold chamber A1 through inner cavity 50 of hollow joint pillar 48 and connecting hole 51 of bolt 49

In further, metal mold chamber B1 is mounted in male mold B as well, and, steam valve B2 and drain valve B3 are connected with this metal mold chamber B1. And, cooling water valve B4 is connected with pipe for cooling 9 which is mounted in metal mold chamber B1, and from the nozzle (not shown) at a prescribed site of pipe for cooling 9, cooling water is possible to be sprayed out. In male mold B, feeder 12 which will fill expanded beads 11 into mold pattern 7 is mounted. On the other inner mold 61 which is fixed on this male mold B, a plural number of steam holes 13 which are connected with metal mold chamber B1 are formed.

At this stage, as surface skin material of thermoplastic resin 3 will become the surface skin of cellular molded article in mold pattern having surface skin 42, coloring to a required color in advance by employing a coloring agent or the like according to its use may be made.

To place surface skin material of thermoplastic resin 3 on one of inner molds 41, a formed article in advance to conform to the shape of design face 44a of this inner mold 41 by means of vacuum forming or the like with employing other metal mold or such others may be employed, however, to omit such work, it is preferable to conduct the thermo-forming such as vacuum forming in inner mold 41. As the thermo-forming, for example, air-pressure forming, vacuum-air pressure forming or the like may be employed other than the vacuum forming.

In order to carry out the thermo-forming in inner mold 41, heat softened surface skin material of thermoplastic 3 in advance is contacted with inner mold 41, and then, by evacuating the air between inner mold 41 and surface skin material of thermoplastic resin 3, surface skin material of thermoplastic resin 3 is made to tight contact or the like with design face 44a of inner mold 41. In this case, in order to make the thermo-forming effectively by minimizing the heat drop of heat softened surface skin material of thermoplastic resin 3, preheating design face 44a at a prescribed temperature may be carried out, however, this preheating can be made by supplying steam S into chamber 43 by opening steam valve A2.

In this occasion, to prevent temperature drop of surface skin material of thermoplastic resin 3 which is on processing of the thermo-forming, continuous heating during the thermo-forming or multi-step heating which changes the setting temperature suitably in stepwise from the beginning of preheating can be applicable. And, in a case that surface skin material of thermoplastic resin 3 is composed of an olefin resin, the temperature for thermo-forming is set up at in a range of from 60 to 150° C., preferably from 60 to 130° C., more preferably from 70 to 120° C. In a case of lower than 60° C., surface skin material of thermoplastic resin 3 will not soften enough, while in a case of higher than 150° C., excessive softening of it will happen, and therefore these are not desirable.

As the heating medium, it is not limited to steam S but others such as heated oil and heated water can also be applied. For cooling down design face 44a at a time of taking out from the mold pattern or the like, supplying cooling water or spraying cooling water into chamber 43 by opening cooling water valve A4 is carried out, however, in this case, oil, solution or other cooling medium can also be applied.

The number of chamber 43 is not particularly limited, but a plural number can be mounted if necessary, and design face 44a can be made to be heated up and cooled down by portion to portion. In this step, in a case that heating chamber 43 which is connected with steam valve A2 or the like, and cooling chamber 43 which is connected with cooling water valve A4 or the like, are mounted individually each other, there is a merit that, even in a case of employing different mediums for heating and cooling respectively, each of them can be recycled.

As is in the above, by means that at least one chamber 43 is mounted in inner mold 41, as metal mold chamber A1 is not pressurized, inner mold 41 can be preheated even in a condition of mold pattern being opened. Consequently, there is a merit that the molding cycle of cellular molded article in mold pattern having surface skin 42 can be shortened.

On the other hand, by forming a plural number of ventilation holes 46 on inner mold 41, there is a merit that the thermo-forming of surface skin material of thermoplastic resin 3 can easily be carried out in this inner mold 41. By means that these ventilation holes 46 are disconnected with chamber 43, and at the same time, they are connected with metal mold chamber A1, there is a merit that it will not cause an insufficient molding by sticking drain or the like on surface skin material of thermoplastic resin 3, and at the same time, pressure reducing valve A5 is only connected with metal mold chamber A1 without piping to ventilation hole 46 individually.

Furthermore, by means that inner mold 41 is composed by surface mold 44 and at least one of back plate 45, there is a merit that inner mold 41 having chamber 43 in its inside can easily be produced. By unification to one piece of these surface mold 44 and back plate 45 through hollow joint pillar 48, as the joint part and the pressure reducing line can be made to use commonly, there is a merit of making cost down. Number, shape or the like of such hollow joint pillar 48 is not particularly limited, but although there may be ventilation hole 46 without equipping hollow joint pillar 48, as it is necessary to connect with pipe for pressure reducing valve A5 individually, it is desirable to make an unification to one piece at all of the pressure reducing lines through hollow joint pillar 48. In this stage, there may be hollow joint pillar 48 without forming ventilation hole 46, other joint member or the like.

After placing surface skin material of thermoplastic resin 3 on one of inner mold 41, as is illustrated in FIG. 12, clumping the mold and filling expanded beads 11 into mold pattern 7 from feeder 12 are carried out. At this stage, as is in the above mentioned, clumping may be made to a condition of having a small opening between the mold patterns (cracking condition).

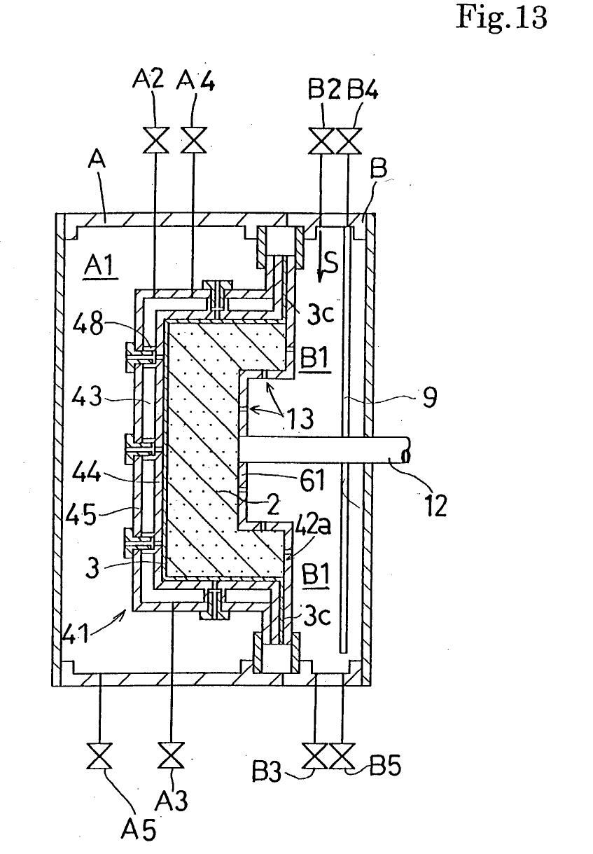

Then, as illustrated in FIG. 13, by opening steam valve B2 which is connected with metal mold chamber B1 of male mold B, steam S is fed into mold pattern 7 from steam holes 13 of the other inner mold 61, and expanded beads 11 are expanded by heat. At this heat expansion molding, to prevent from causing an insufficient unification, the above mentioned preheating, steaming, evacuation of drain or the like may be carried out according to its necessity.

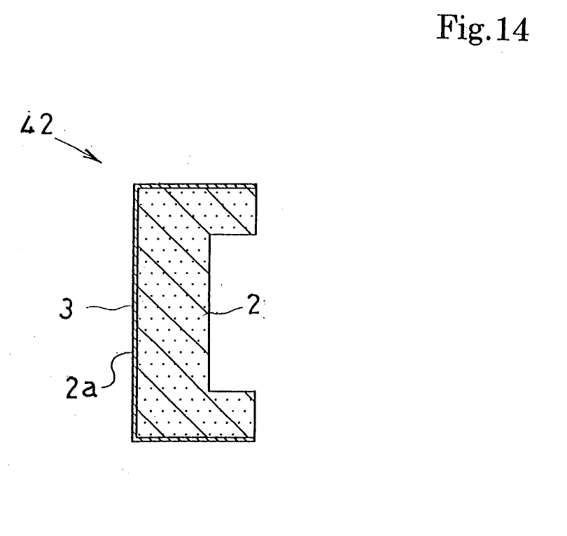

After that, by cooling it down if necessary, and by taking it out from the mold pattern by means of opening the mold pattern, cellular molded article in mold pattern having surface skin 42a of having edge part 3c, which is composed of cellular molded article in mold pattern 2 having been formed by the expansion molding of expanded beads 11 in mold pattern and surface skin material of thermoplastic resin 3 which is melt united to one piece with surface 2a of this cellular molded article in mold pattern 2, can be obtained. Continuously, by cutting off edge part 3c according to its necessity, cellular molded article in mold pattern having surface skin 42 as illustrated in FIG. 14 can be obtained.

In this embodiment, explanation has been made on a case that chamber 43 is mounted in one of inner mold 41 being fixed on female mold A, however, it is not limited to this. In a case that surface skin material of thermoplastic resin 3 is placed on the other inner mold 61 being fixed on male mold B, chamber 43 may be mounted in this other inner mold 61. The other inner mold 61 in this case can be constituted as same as the above mentioned one of inner mold 41. Also, mold pattern C can be made to clump and open in vertical direction other than in horizontal direction.

### EFFECTIVENESS OF THE INVENTION AS WELL AS POSSIBILITY FOR INDUSTRIAL USE

As mentioned above, according to the invention claimed in claim 1, the composite molded article of light weight can be produced and as the composite molded article can easily be produced by a simultaneous unification molding to one piece, the production cost can be made lower.

According to the invention claimed in claim 2, as one or more kinds of surface skin material having the different properties and outward appearance of the surface skin material of thermoplastic resin are melt united to one piece on the portion of the surface of the surface skin material of thermoplastic resin, after producing of the composite molded article, the portion of the surface skin material can be seen independently from the portion of surface skin material of thermoplastic resin. Therefore, decoration property can easily be given to the composite molded article.

According to the invention claimed in claim 3, as the quality of surface skin material is different from the quality of surface skin material of thermoplastic resin, these surface skin material having the different properties and outward appearance can easily be made different respectively.

According to the invention claimed in claim 4, as the surface skin material is made of cloth, knitting or non-woven fabric, decoration property can be given more effectively to the composite molded article.

According to the invention claimed in claim 5 and claim 12, as the surface skin material or the lining material is composed of thermoplastic resin, the surface skin material or the lining material can also be made a direct heat melt adhesion on the surface skin material of thermoplastic resin.

According to the invention claimed in claim 6, as the cellular molded article in mold pattern, the surface skin material of thermoplastic resin and the surface skin material are composed of an olefin resin, it is so called all olefin, consequently the composite molded article can be easily recycled.

According to the invention claimed in claim 7 and claim 14, as the above mentioned olefin resin is a polypropylene, the durability of the composite molded article is excellent.

According to the invention claimed in claim 8, as a surface treatment is performed at least on either the surface skin material of thermoplastic resin or the surface skin material, weatherabilty and durability against scratching of the composite molded article can be raised.

According to the invention claimed in claim 9, as at least the portion of the edge part of surface skin material is inserted in the groove part, the edge part inserted in the groove part is hidden and thus it is hardly seen after the producing of the composite molded article, by this reason, an appearance of a composite molded article is improved and also it can prevent peeling off from the edge part.

According to the invention claimed in claim 10, as the lining material is laminated on the back face of surface skin material, a different touch can be given to the surface skin material.

According to the invention claimed in claim 11, as the lining material is a cross-linked cellular article, the touch of the composite molded article is good, and its durability or the like is also excellent.

According to the invention claimed in claim 13, as the lining material is composed of an olefin resin, recycling of this lining material is easy.

According to the invention claimed in claim 15, as the composite molded article is an interior trim material for automobile, ship, train or aircraft, a light weight and low cost automobile or the like can be provided.

According to the invention claimed in claim 16, as at least one chamber is mounted inside, the metal mold chamber to which this inner mold is fixed will never be pressurized. By this reason, preheating of the inner mold can be made even in a condition of opening the mold pattern, and therefore, the molding cycle of the cellular molded article in mold pattern having surface skin can be shortened.

According to the invention claimed in claim 17, as one chamber for heating and one chamber for cooling are mounted respectively, even in a case that the compositions of heating medium and cooling medium are different each other, each of them can be cycled independently.

According to the invention claimed in claim 18, as a plural number of ventilation holes are formed, heat forming of the surface skin material of thermoplastic resin can easily be carried out in this inner mold.

According to the invention claimed in claim 19, as the ventilation holes are disconnected with the chamber and connected with the metal mold chamber, there will not cause an insufficient molding by sticking drain or the like on the surface skin material of thermoplastic resin, at the same time, the pressure reducing valve may simply be connected with the metal mold chamber without piping to the ventilation holes individually.

According to the invention claimed in claim 20, as it is consisted of the surface mold and at least one back plate, fabrication of it is simple.

According to the invention claimed in claim 21, as the surface mold and the back plate are united to one piece through the hollow joint pillar, the joint part and the pressure reducing line can be made to be common use, and thus cost down of it can be made.

According to the invention claimed in claim 22, as it is equipped with such inner mold as described above, it has similar effect to claim 16 to 21.

Although the invention has been described in its preferred form with certain degree of particularity, it is understood that the present disclosure of the preferred form has been changed in the details of construction and the combination and arrangement of parts may be resorted to without departing from the spirit and the scope of the invention as hereinafter claimed.

What is claimed is:

1. A producing method of a composite molded article which is characterized by a process of that, a surface skin material of thermoplastic resin is placed on either one of two metal mold patterns which compose a mold pattern, and after clumping the mold, by means of an expansion molding in this mold pattern, a cellular molded article in mold pattern to be formed and the above mentioned surface skin material of thermoplastic resin are melt united to one piece, wherein before placing the surface skin material of thermoplastic resin, one or more kinds of surface skin material is placed on either one of the two metal molds, and at the same time or before then, the surface skin material of thermoplastic resin and the surface skin material are melt united to one piece.

2. A producing method of a composite molded article as defined in claim 1 which is characterized by a process of that one or more kinds of surface skin material having the different properties and outward appearance of the surface skin material of thermoplastic resin are melt united to one piece on a portion of the surface of the surface skin material of thermoplastic resin.

3. A producing method of a composite molded article as defined in claim 1, wherein the quality of the surface skin material is different from the quality of the surface skin material of thermoplastic resin.

4. A producing method of a composite molded article as defined in claim 1, wherein the surface skin material is made of cloth, knitting or non-woven fabric.

5. A producing method of a composite molded article as defined in claim 1, wherein the surface skin material is composed of a thermoplastic resin.

6. A producing method of a, composite molded article as defined in claim 5 wherein the cellular molded article in mold pattern, the surface skin material of thermoplastic resin and the surface skin material are composed of an olefin resin.

7. A producing method of a composite molded article as defined in claim 6 wherein the olefin resin is a polypropylene resin.

8. A producing method of a composite molded article as defined in claim 1 wherein a surface treatment is performed at least on either the surface skin material of thermoplastic resin or the surface skin material.

9. A producing method of a composite molded article as defined in claim 1 wherein at least a portion of the edge part of the surface skin material is inserted in a groove part which is formed on the surface of the surface skin material of thermoplastic resin.

10. A producing method of a composite molded article as defined in claim 1 wherein the surface skin material is laminated with a lining material on its back face.

11. A producing method of a composite molded article as defined in claim 10 Wherein the lining material is a cross-linked cellular article.

12. A producing method of a composite molded article as defined in claim 10 wherein the lining material is composed of a thermoplastic resin.

13. A producing method of a composite molded article as defined in claim 12 wherein the lining material is composed of an olefin resin.

14. A producing method of a composite molded article as defined in claim 13 Wherein the olefin resin is a polypropylene resin.

15. A producing method of a composite molded article as defined in claim 1 is that the composite molded article is an interior trim material for automobile, ship, train or aircraft.

16. An inner mold which is used for producing a cellular molded article in mold pattern by employing a step that, on either one of the two inner molds being fixed on each of two metal mold patterns which compose a mold pattern, a surface skin material of thermoplastic resin is placed then clumping the mold, and thereafter, by an expansion molding of it in this mold pattern, a cellular molded article in mold pattern to be formed and the surface skin material of thermoplastic resin are melt united to one piece, wherein, the inner mold is characterized in that at least one chamber is mounted in the above mentioned one of inner molds.

17. An inner mold which is used for producing a cellular molded article in mold pattern having surface skin as defined in claim 16, wherein it is characterized in that at least one chamber for heating and one chamber for cooling are mounted in the above mentioned one of inner molds.

18. An inner mold which is used for producing a cellular molded article in mold pattern having surface skin as defined in claim 16, wherein it is characterized in that a plural number of ventilation holes are formed on the above mentioned one of inner molds.

19. An inner mold which is used for producing a cellular molded article in mold pattern having surface skin as defined in claim 18, wherein it is characterized in that, the ventilation holes are disconnected with the chamber, and these holes are connected with a metal mold chamber which is mounted in the metal mold with which the above mentioned one of inner molds is fixed.

20. An inner mold which is used for producing a cellular molded article in mold pattern having surface skin as defined in claim 16, wherein it is characterized in that, it is composed of a surface mold consisting a design face of the above mentioned one of inner molds and at least one back plate which is fixed so as to form the chamber on back face of this surface mold.

21. An inner mold which is used for producing a cellular molded article in mold pattern having surface skin as defined in claim 20, wherein it is characterized in that, ventilation holes being formed on the surface mold and chamber holes being formed on the back plate are melt united to one piece through at least one hollow joint pillar which is connecting with both of them.

22. A metal mold which is used for producing a cellular molded article in mold pattern having surface skin, wherein it is characterized in that it is equipped with the inner mold as defined in claim 16.
